(19) United States
(12) Patent Application Publication
(10) Pub. No.: US 2022/0236552 A1
(43) Pub. Date: Jul. 28, 2022

(54) OPTICAL DEVICE

(71) Applicant: Chia-Hui CHEN, Kowloon (HK)

(72) Inventor: Han-Che CHEN, Taipei City (TW)

(21) Appl. No.: 17/158,414

(22) Filed: Jan. 26, 2021

(51) Int. Cl. G02B 23/16; G02B 23/14; H04N 7/18; G01S 17/08

(52) U.S. Cl. CPC G02B 23/16; G02B 23/14; H04N 5/2256; G01S 17/08; H04N 7/18

(57) ABSTRACT

An optical device configured to observe a target is provided, including a main body, a display module, an object lens module, and an eyepiece module. The main body has an upper portion, a lower portion and a hollow portion connected to each other. The display module is accommodated in the hollow portion to display an image of a target. The object lens module is disposed on a front side of the main body to generate the image of the target. The eyepiece module is disposed on a rear side of the main body. The hollow portion of the main body forms a first crescent-shaped structure protruding from the upper left side of the object lens module and a second crescent-shaped structure protruding from the upper right side of the object lens module to receive the display module.

### BACKGROUND OF THE INVENTION

### Field of the Invention

The application relates in general to an optical device, and in particular, to an optical device provided with a display module.

### Description of the Related Art

Thanks to the ongoing development of technology, electronic products such as optical binoculars and monoculars are becoming increasingly versatile. With continuous improvements in performance, the application of these devices will improve. For example, optical binoculars and monoculars used in hunting are often equipped with night-vision functionality, and they include an infrared light-emitting unit that emits infrared light, which allows the users to see more clearly at night. However, users demand high quality and versatility from their binoculars and monoculars. Therefore, it is an important issue to provide a device that is more user-friendly and that can be more widely used.

### BRIEF SUMMARY OF INVENTION

In view of the aforementioned problems, the object of the invention is to provide an optical device configured to observe a target. The optical device includes a main body, a display module, an object lens module, and an eyepiece module. The main body has an upper portion, a lower portion and a hollow portion connected to each other. The display module is accommodated in the hollow portion of the main body and configured to display an image of the target. The object lens module is disposed on a front side of the main body and configured to generate the image of the target. The shape of the hollow portion corresponds to the display module and forms a first crescent-shaped structure and a second crescent-shaped structure. The first crescent-shaped structure protrudes from the upper left side of the object lens module. The second crescent-shaped structure protrudes from the upper right side of the object lens module. The eyepiece module is disposed on a rear side of the main body. The user can see an image of the target displayed on the display module via the eyepiece module. The invention is particularly useful when embodied as an add-on device to a telescopic gun sight, such as a night-vision or day-vision gun sight.

In some embodiments, the first and second crescent-shaped structures have a substantially triangular flat surface facing the target.

In some embodiments, the hollow portion is higher than the upper portion.

In some embodiments, the eyepiece module has a viewing window and an eye guard surrounding the viewing window.

In some embodiments, the viewing window has a convex lens.

In some embodiments, the eye guard includes plastic or rubber material.

In some embodiments, the optical device further includes an infrared light module disposed on the front of the main body and configured to emit infrared light to the target.

In some embodiments, the optical device further includes a plurality of buttons disposed on the upper portion of the main body.

The optical device as claimed in claim 1, wherein the main body further has a slip resistant texture formed on a lateral side of the lower portion.

In some embodiments, the main body further has a flange formed on the rear side of the main body, and the flange is higher than the upper portion.

In some embodiments, the optical device further includes a rangefinder module disposed in the upper portion of the main body and configured to measure the distance between the rangefinder module and the target.

In some embodiments, the hollow portion is located below the rangefinder module.

In some embodiments, the rangefinder module is a Lidar that includes a light emitter and a light receiver.

In some embodiments, the optical device further includes a screen disposed on the upper portion and electrically connected to the rangefinder module.

In some embodiments, the optical device further includes a rib and two columns of buttons disposed on the upper portion of the main body, wherein the rib is located between the two columns of buttons.

In some embodiments, the screen is angled relative to the buttons.

### BRIEF DESCRIPTION OF DRAWINGS

The invention can be more fully understood by reading the subsequent detailed description and examples with references made to the accompanying drawings, wherein:

FIG. 1 is a front perspective view of an optical device 100 in accordance with an embodiment of the invention;

FIG. 2 is a rear perspective view of the optical device 100 in FIG. 1;

FIG. 3 is a left view of the optical device 100 in FIGS. 1 and 2;

FIG. 4 is a top plan view of the optical device 100 in FIGS. 1 and 2;

FIG. 5 is a front view of the optical device 100 in FIGS. 1 and 2;

FIG. 6 is a rear view of the optical device 100 in FIGS. 1 and 2;

FIG. 7 is a front perspective view of an optical device 200 in accordance with another embodiment of the invention;

FIG. 8 is a rear perspective view of the optical device 200 in FIG. 7;

FIG. 9 is a left view of the optical device 100 in FIGS. 7 and 8;

FIG. 10 is a top plan view of the optical device 200 in FIGS. 7 and 8;

FIG. 11 is a front view of the optical device 200 in FIGS. 7 and 8; and

FIG. 12 is a rearview of the optical device 200 in FIGS. 7 and 8.

### DETAILED DESCRIPTION OF INVENTION

The making and using of the embodiments of the optical device are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

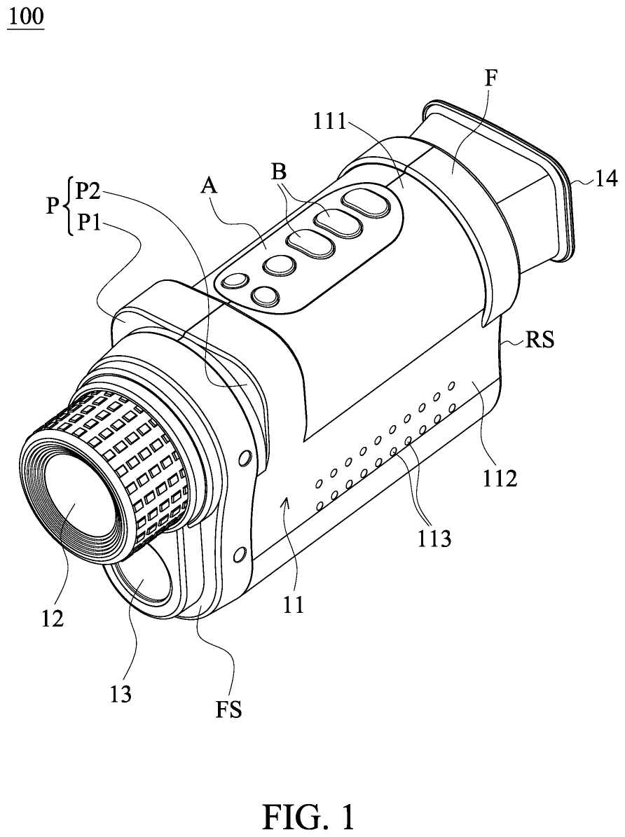

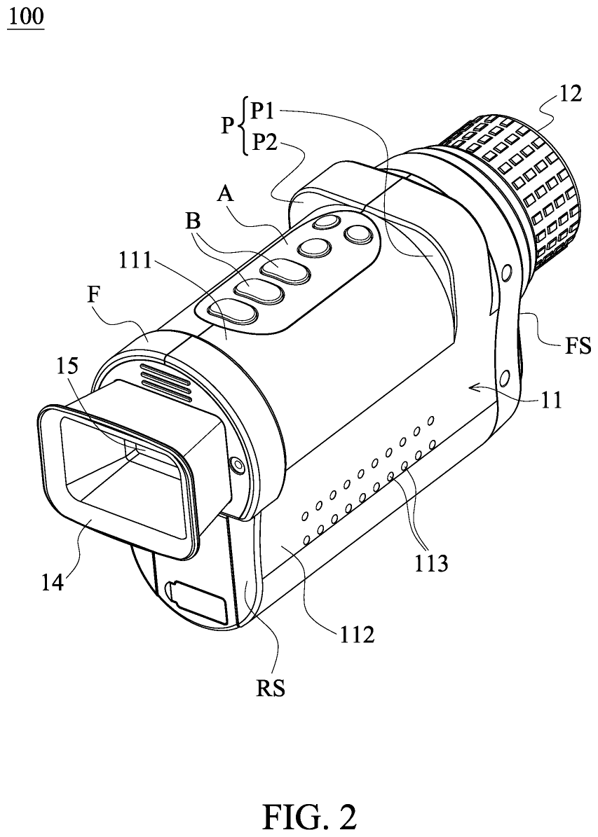

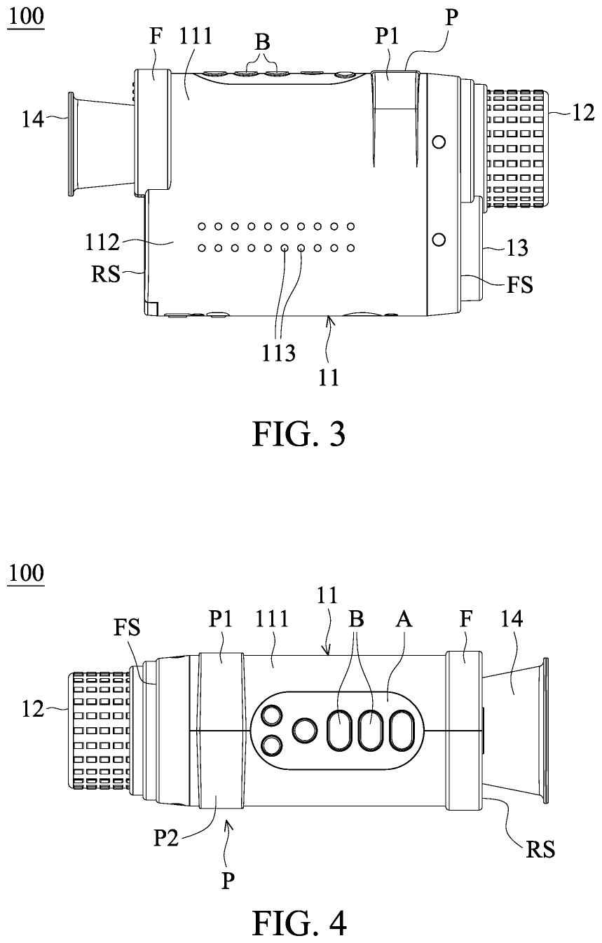

FIG. 1 is a front perspective view of an optical device 100 in accordance with an embodiment of the invention, and FIG. 2 is a rear perspective view of the optical device 100 in FIG. 1. FIG. 3 is a left view of the optical device 100 in FIGS. 1 and 2, FIG. 4 is a top plan view of the optical device 100 in FIGS. 1 and 2, FIG. 5 is a front view of the optical device 100 in FIGS. 1 and 2, and FIG. 6 is a rear view of the optical device 100 in FIGS. 1 and 2.

Referring to FIGS. 1-6, the optical device 100 in this embodiment is a night-vision monocular (NVM), especially suitable for use outdoors in the dark. Here, the optical device 100 is particularly useful when embodied as an add-on device to a telescopic gun sight, such as a night-vision or day-vision gun sight, and it can be used to observe, aim, and zoom in on a scene or target, for example, used for hunting games. The optical device 100 primarily comprises a main body 11, an object lens module 12, an infrared light module 13, a rubber eye guard 14, and a viewing window 15. The object lens module 12 and the infrared light module 13 are disposed on a front side FS of the main body 11 (FIG. 1). The eye guard 14 and the viewing window 15 are disposed on a rear side RS of the main body 11 (FIG. 2). It should be noted that the infrared light module 13 can emit infrared light to a target in the dark, and the object lens module 12 can receive infrared light reflected by the target. Moreover, an image sensor (e.g. CCD or CIS image sensor) inside the main body 11 can generate a digital image of the target accordingly.

Still referring to FIGS. 1-6, the main body 11 has an upper portion 111, a lower portion 112, a flange F, and a hollow portion P connected to each other. The hollow portion P is located on the front side FS of the main body 11 and higher than the upper portion 111. The flange F is located on the rear side RS of the main body 11 and higher than the upper portion 111. In some embodiments, the hollow portion P and the upper portion 111 may form a continuous and smooth surface, and the hollow portion P may not protrude from or higher than the upper portion 1111 of the main body 11, but the invention is not limited thereto.

Several buttons B are disposed on the top A of the upper portion 111, so as to make operation of the optical device 100 convenient. Moreover, a slip-resistant texture with several round recesses 113 is formed on the lateral side of the lower portion 112. Therefore, the user can easily grip the main body 11 for handheld use.

In this embodiment, a display module (e.g. LCD or OLED panel module) is accommodated in the hollow portion P of the main body 11 and electrically connected to the image sensor. The display module is configured to show a digital image of the target that is generated by the image sensor. Since the display module has a rectangular structure, the shape of the hollow portion P corresponds to the profile of the display module, so as to form an appropriate space for accommodating and to restrict the display module in the main body 11.

Additionally, the eye guard 14 and the viewing window 15 in FIGS. 2 and 6 have a rectangular shape that corresponds to the display module. The eye guard 14 surrounds and protects the viewing window 15, so as to constitute a comfortable eyepiece module of the optical device 100. In this embodiment, the eye guard 14 may comprise plastic or rubber material, and the viewing window 15 may comprise a convex lens that can magnify the image shown on the display module. Hence, a large, clear image of the target can be seen by a user via the viewing window 15.

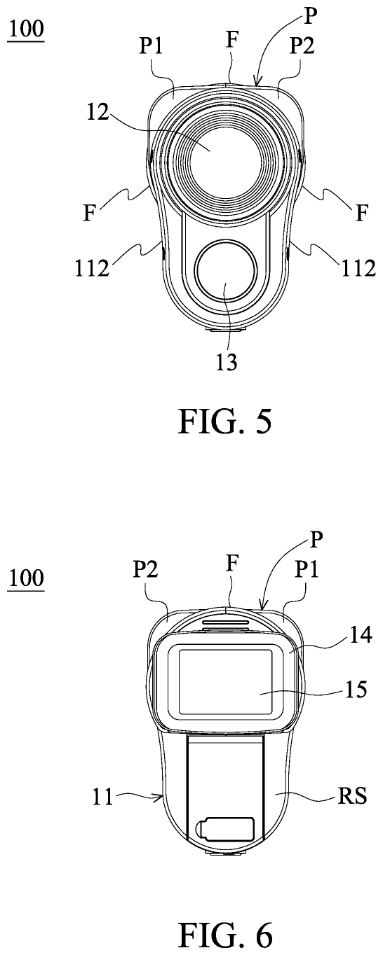

In FIGS. 1-2 and 5-6, the hollow portion P forms a first crescent-shaped structure P1 and a second crescent-shaped structure P2 protruding from the object lens module 12 and the upper portion 111 of the main body 11. When viewed in a direction parallel to an optical axis of the object lens module 12 (FIG. 5), the first crescent-shaped structure P1 protrudes from the upper left side of the object lens module 12, and the second crescent-shaped structure P2 protrudes from the upper right side of the object lens module 12.

It should be noted that the shape of the first and second crescent-shaped structures P1 and P2 correspond to the two corners of the rectangular display module that fit in the hollow portion P, and the first and second crescent-shaped structures P1 and P2 each have a substantially triangular flat surface facing the target (FIGS. 1 and 5).

With the special profile of the hollow portion P, a large display module can be provided inside the main body 11, whereby a large, clear image of the target can be seen by a user via the viewing window 15.

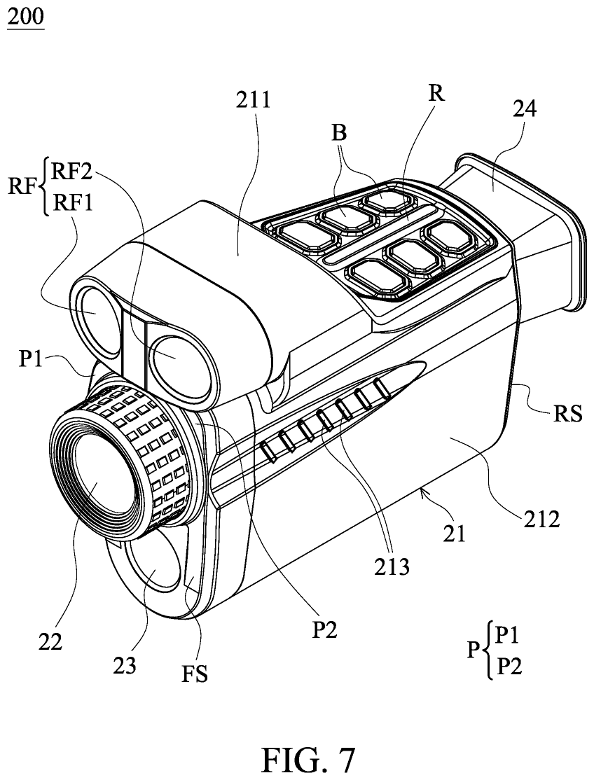

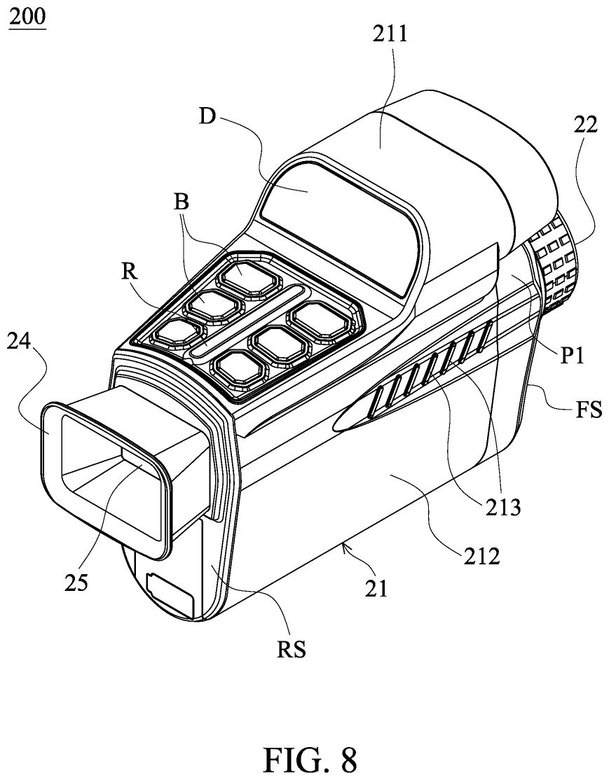

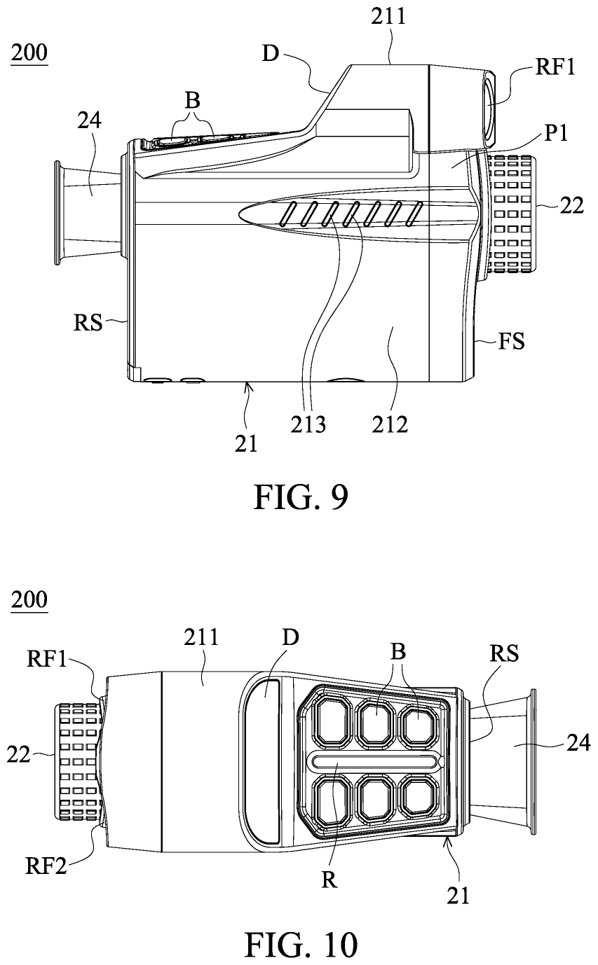

FIG. 7 is a front perspective view of an optical device 200 in accordance with another embodiment of the invention, and FIG. 8 is a rear perspective view of the optical device 200 in FIG. 7. FIG. 9 is a left view of the optical device 100 in FIGS. 7 and 8, FIG. 10 is a top plan view of the optical device 200 in FIGS. 7 and 8, FIG. 11 is a front view of the optical device 200 in FIGS. 7 and 8, and FIG. 12 is a rear view of the optical device 200 in FIGS. 7 and 8.

The optical device 200 in this embodiment is a night-vision monocular (NVM) provided with a rangefinder module, especially suitable for use outdoors in the dark. Here, the optical device 200 is particularly useful when embodied as an add-on device to a telescopic gun sight, such as a night-vision or day-vision gun sight, and it can be used to observe, aim, and zoom in on a scene or target, for example, used for hunting games. This embodiment is different from the optical device 100 of FIGS. 1-6 in that the optical device 200 further comprises a rangefinder module RF configured to measure a distance from the rangefinder module RF to a target.

As shown in FIGS. 7-12, the optical device 200 primarily comprises a main body 21, an object lens module 22, an infrared light module 23, a rubber eye guard 24, a viewing window 25, and a rangefinder module RF. The object lens module 22 and the infrared light module 23 are disposed on a front side FS of the main body 21 (FIG. 7). The eye guard 24 and the viewing window 25 are disposed on a rear side RS of the main body 21 (FIG. 8). Similar to the embodiment of FIGS. 1-6, the infrared light module 23 can emit infrared light to a target in the dark, and the object lens module 22 can receive infrared light reflected by the target. An image sensor (e.g. CCD or CIS image sensor) inside the main body 11 can generate a digital image of the target accordingly.

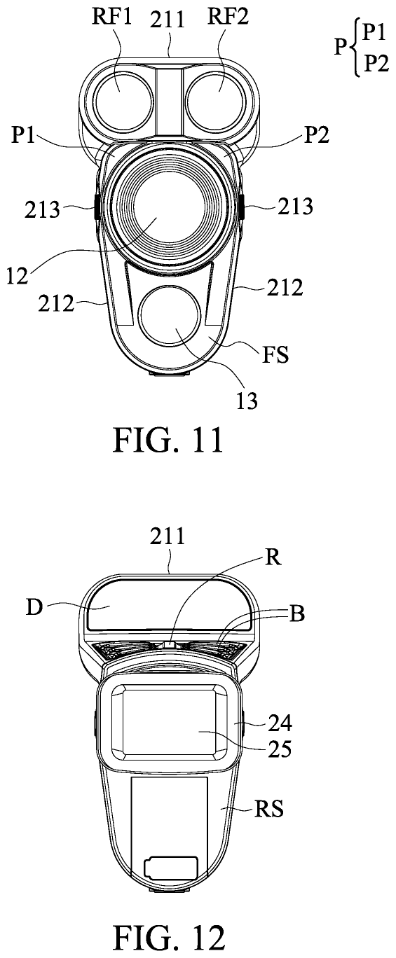

Still referring to FIGS. 7-12, the main body 21 has an upper portion 211, a lower portion 212, and a hollow portion P (including a first crescent-shaped structure P1 and a second crescent-shaped structure P2) connected to each other, wherein the hollow portion P is formed on the front side FS of the main body 21. As shown in FIGS. 7 and 11, the hollow portion P forms a first crescent-shaped structure P1 and a second crescent-shaped structure P2 protruding from the object lens module 22 in different directions. Specifically, when viewed in a direction parallel to an optical axis of the object lens module 22 (FIG. 11), the first crescent-shaped structure P1 protrudes from the upper left side of the object lens module 22, and the second crescent-shaped structure P2 protrudes from the upper right side of the object lens module 22.

In this embodiment, a display module (e.g. LCD or OLED panel module) is accommodated in the hollow portion P of the main body 21 and electrically connected to the image sensor. The display module is configured to show a digital image of the target that is generated by the image sensor. Since the display module has a rectangular structure, the hollow portion P has a shape that corresponds to the profile of the display module, so as to form an appropriate space for accommodating and positioning the display module in the main body 21.

The eye guard 24 and the viewing window 25 in FIGS. 8 and 12 have a rectangular shape that corresponds to the display module, wherein the eye guard 24 surrounds and protects the viewing window 25, so as to constitute a comfortable eyepiece module of the optical device 200. In this embodiment, the eye guard 24 may comprise plastic or rubber material, and the viewing window 25 may comprise a convex lens that can magnify the image shown on the display module. Hence, a large, clear image of the target can be seen by a user via the viewing window 25.

The rangefinder module RF may comprise a Lidar that includes a light emitter RF1 and a light receiver RF2, wherein the light emitter RF1 can emit laser light to the target, and the light receiver RF2 can receive laser light that is reflected by the target, so as to measure a distance from the rangefinder module RF to the target. It should be noted that the light emitter RF1 and the light receiver RF2 are located above the first and second crescent-shaped structures P1 and P2 of the hollow portion P. Furthermore, as shown in FIGS. 7 and 11, the first and second crescent-shaped structures P1 and P2 each have a substantially triangular flat surface facing the target.

Two columns of buttons B are disposed on the top of the upper portion 211, and a rib R is formed between the two columns of buttons B, so as to achieve convenient operation of the optical device 200. In this embodiment, the optical device 200 further comprises a screen D disposed on the upper portion 211 (FIGS. 8-10 and 12), wherein the screen D is angled relative to the buttons B and the rib R. Moreover, a slip-resistant texture with several longitudinal protrusions 213 is formed on a lateral side of the lower portion 212, whereby the user can easily grip the main body 21 by hands during usage.

In summary, the invention provides an optical device that comprises a main body, a display module disposed in the main body, and an object lens module disposed on a front side of the main body. The main body forms a hollow portion including a first crescent-shaped structure and a second crescent-shaped structure corresponding to the shape of the display module, therefore the display module can be accommodated in the main body to show a large, clear image of the target.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An optical device, configured to observe a target, comprising:
a main body, having an upper portion, a lower portion and a hollow portion connected to each other;
a display module, accommodated in the hollow portion of the main body and configured to display an image of the target;
an object lens module, disposed on a front side of the main body and configured to generate the image of the target, wherein the hollow portion has a shape that corresponds to the display module and that forms a first crescent-shaped structure and a second crescent-shaped structure, the first crescent-shaped structure protrudes from an upper left side of the object lens module, and the second crescent-shaped structure protrudes from an upper right side of the object lens module; and
an eyepiece module, disposed on a rear side of the main body, wherein the image of the target displayed on the display module can be seen by a user using the eyepiece module.

2. The optical device as claimed in claim 1, wherein the first crescent-shaped structure and the second crescent-shaped structure each has a substantially triangular flat surface facing the target.

3. The optical device as claimed in claim 1, wherein the hollow portion is higher than the upper portion.

4. The optical device as claimed in claim 1, wherein the eyepiece module has a viewing window and an eye guard surrounding the viewing window.

5. The optical device as claimed in claim 4, wherein the viewing window comprise a convex lens.

6. The optical device as claimed in claim 4, wherein the eye guard comprises plastic or rubber material.

7. The optical device as claimed in claim 1, further comprising an infrared light module disposed on the front side of the main body and configured to emit infrared light to the target.

8. The optical device as claimed in claim 1, further comprising a plurality of buttons disposed on the upper portion of the main body.

9. The optical device as claimed in claim 1, wherein the main body further has a slip resistant texture formed on a lateral side of the lower portion.

10. The optical device as claimed in claim 1, wherein the main body further has a flange formed on the rear side of the main body, and the flange is higher than the upper portion.

11. The optical device as claimed in claim 1, further comprising a rangefinder module disposed in the upper portion of the main body and configured to measure a distance between the rangefinder module and the target.

12. The optical device as claimed in claim 11, wherein the first crescent-shaped structure and the second crescent-shaped structure each has a flat surface facing the target.

13. The optical device as claimed in claim 11, wherein the hollow portion is located below the rangefinder module.

14. The optical device as claimed in claim 11, wherein the eyepiece module has a viewing window and an eye guard surrounding the viewing window.

15. The optical device as claimed in claim 14, wherein the viewing window comprise a convex lens.

16. The optical device as claimed in claim 14, wherein the eye guard comprises plastic or rubber material.

17. The optical device as claimed in claim 11, wherein the rangefinder module comprises a Lidar that includes a light emitter and a light receiver.

18. The optical device as claimed in claim 11, further comprising a screen disposed on the upper portion and electrically connected to the rangefinder module.

19. The optical device as claimed in claim 18, further comprising a rib and two columns of buttons disposed on the upper portion of the main body, wherein the rib is located between the two columns of buttons.

20. The optical device as claimed in claim 19, wherein the screen is angled relative to the buttons.
